(19) United States
(12) Patent Application Publication
(10) Pub. No.: US 2009/0289799 A1
(43) Pub. Date: Nov. 26, 2009

(54) MEDICAL MONITORING METHOD AND SYSTEM

(75) Inventors: Gerhard Tivig, Boeblingen (DE); Sebastian Hebler, Bad Lausick (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., Eindhoven (NL)

(21) Appl. No.: 11/721,762

(22) PCT Filed: Dec. 19, 2005
(86) PCT No.: PCT/IB05/54309

§ 371 Date: Jun. 14, 2007

(30) Foreign Application Priority Data
Dec. 22, 2004 (EP) 04106877.6

(51) Int. Cl. G08B 23/00; G06Q 50/00

(52) U.S. Cl. 340/573.1; 705/2

(57) ABSTRACT

The present invention relates to a method and system (1) of medical monitoring. Furthermore the present invention relates to a computer program for controlling a medical monitoring system (1). In order to provide an improved monitoring technique that allows a more effective analysis of monitored data, a medical monitoring method is provided, the method comprising the steps of acquiring medical data of a patient, analyzing the medical data with respect to a number of event parameters (17, 18, 19, 20), whereas a number of user-definable trigger conditions (10) are assigned to each of the event parameters (17, 18, 19, 10), and in case a number of said trigger conditions (10) are detected providing medical context information (15) and activating an event notification (22). In other words, not only is medical information (15) provided, additionally an event notification (22) is activated, if a number of trigger conditions (10) are detected. The additional real-time event notification enables the clinical staff to respond immediately to a critical situation of the patient or the like. Furthermore the provided medical context information (15) relating to the event can be reviewed directly. This enables the clinical staff to initiate treatment at a very early point of time.

The present invention relates to a method and system of medical monitoring. Furthermore the present invention relates to a computer program for controlling a medical monitoring system.

In a clinical environment a patient monitor is used for the observation of the condition of a patient. The primary function of a patient monitor is to warn the clinical staff on changes in the status of the patient. Typically a limit alarm mechanism is implemented in such patient monitors. Thereby an alarm is activated if a measurement exceeds a user-defined threshold.

As a retrospective documentation method it is known to provide medical data (“episode”) of the patient as context information for later review and documentation. The providing of medical data is carried out in case a certain clinical condition (“event”), e.g. a low blood pressure, is detected during monitoring of the patient.

It is an object of the present invention to provide an improved monitoring technique that allows a more effective analysis of monitored data.

This object is achieved according to the invention by a medical monitoring method, comprising the steps of acquiring medical data of a patient, analyzing the medical data with respect to a number of event parameters, whereas to each of the event parameters a number of user-definable trigger conditions are assigned, and in case a number of said trigger conditions are detected, providing medical context information and activating an event notification.

The object of the present invention is also achieved by a medical monitoring system, comprising an acquiring module adapted to acquire medical data of a patient, an analyzing module adapted to analyze the medical data with respect to a number of event parameters, whereas to each of the event parameters a number of user-definable trigger conditions are assigned, an information providing module adapted to provide medical context information, and a notification module adapted to activate an event notification in case a number of said trigger conditions are detected.

The object of the present invention is also achieved by a computer program for controlling a medical monitoring system, the computer program comprising computer instructions for analyzing the medical data with respect to a number of event parameters, whereas to each of the event parameters a number of user-definable trigger conditions is assigned, computer instructions to provide medical context information and computer instructions to activate an event notification in case a number of said trigger conditions are detected, when the computer instructions are carried out in a computer. The technical effects necessary according to the invention can thus be realized on the basis of the instructions of the computer program in accordance with the invention. Such a computer program can be stored on a carrier such as a CD-ROM or it can be available over the internet or another computer network. Prior to execution the computer program is loaded into the computer by reading the computer program from the carrier, for example by means of a CD-ROM player, or from the internet, and storing it in the memory of the computer. The computer includes inter alia a central processing unit (CPU), a bus system, memory means, e.g. RAM or ROM etc., storage means, e.g. floppy disk or hard disk units etc. and input/output units. The computer is preferably implemented as part of the medical monitoring system.

A core idea if the invention is that not only medical information is provided. Additionally, an event notification is activated, if a number of trigger conditions are detected. In other words a notification takes place during routine patient monitoring. This is achieved according to the present invention by means of a real-time monitoring, event analysis and event notification technique. The additional real-time event notification enables the clinical staff to respond immediately to a critical situation or the like of the patient. Furthermore, the provided medical context information relating to the event can be reviewed directly. This enables the clinical staff to initiate treatment at a very early point of time.

According to another aspect of the invention complex trigger patterns can be set up to detect earlier the onset of a given clinical pattern allowing the clinical staff then to initiate the appropriate treatment. For example in an operating room there is no need to review events at a later point of time, as provided by the prior art systems. However, according to the present invention, if a clinical pattern occurs, the anesthesiologist can be notified immediately. The present invention enables highly flexible analyzing of medical data using a standard patient monitor. The present technique does not need external computers or the like. It can be carried out using virtually every standard patient monitor available. Thereby only minor modifications are needed.

These and other aspects of the invention will be further elaborated on the basis of the following embodiments which are defined in the dependent claims.

Preferably data of a number of different medical parameters, e.g. heart rate and blood pressure, is acquired by means of the acquiring module. A number of user-definable event parameters are preferably combined within the analyzing module to form one or more condition clusters (“event groups”). Basically any measurement can be set up as an event parameter. The combination of event parameters to an event group is preferably carried out by means of mathematical and/or logical operators, such as AND, OR, NOT etc. by the analyzing module.

There are trigger conditions assigned to the event parameters. An event notification is activated in real time by means of the notification module in case at least a predetermined number of trigger conditions of an event group are detected. For example up to four event parameters (e.g. heart rate, blood pressure, respiration, . . . ) with corresponding trigger conditions can be clustered to an event group. With this method different diseases can be assigned to different event groups in a defined way. In other words an event surveillance is provided, which allows to define event groups expressing specific clinical situations. The user can be informed about these groups and the user can review these events. Preferably for each event an episode is captured which can be reviewed, recorded and reported.

For each event parameter a measurement-specific list of trigger conditions is provided by the user or derived from measurement-related information. For example a trigger condition can be derived from a prior event detected by the measurement. The application of user-defined trigger conditions in the form of a trigger combination for a cluster of measurements is clinically beneficial in cases where the corresponding event notification is activated before a single event condition would individually lead to an alarm. This is especially useful in situations where the patient condition deteriorates gradually. The combination of trigger conditions is preferably carried out again by means of mathematical and/or logical operators, such as AND, OR, NOT etc. by the analyzing module.

The capability of deriving intelligent alerts does not necessarily mean that the amount of alarms will increase. If appropriate alert reduction strategies are provided, it is possible to allow event alerting only for a limited number of cases. For example event notification might be only activated by the notification module if a certain number and/or a certain kind of user-definable trigger conditions are determined at the same time or within the same time period by means of the analyzing module.

According to another preferred embodiment of the invention several event groups, e.g. up to six event groups, can be defined by the user at the same time. Preferably each group can be configured separately. The analyzing of medical data is performed in parallel by the analyzing module with respect to several different event groups. In other words the acquired medical data is analyzed with respect to several trigger conditions of several event groups at the same time. Since each event group might be assigned to a specific disease, clinical diagnoses is supported by the simultaneous use of different event groups. In many cases clinicians do not know exactly what type of “disease pattern” a patient will develop. For example, sepsis syndrome can be linked to early sepsis, sepsis-like illness or sepsis shock. According to the invention for each of these diseases a specific event group can be set up. The high degree of flexibility in terms of event trigger conditions and event notifications allows the clinician to adapt the present invention to virtually any clinical pattern. In other words, the present invention allows the use of a patient monitor for differential diagnosis.

With the present invention a fully customizable event detection system embedded in a patient monitor is provided. The system allows the user to setup the monitor to detect events based upon new findings in the medical literature by adapting the system to the clinical pattern specific needs. If for example clinical studies show the significance of the heart rate variability (HRV) in detecting earlier sepsis or sepsis-like illness in the intensive care unit, setting up an event group using the HRV parameters with appropriate trigger conditions and event notification allow to monitor this clinical situation.

Preferably for each measurement, e.g. for measuring heart rate or blood pressure, a number of trigger conditions are set within the analyzing module, e.g. thresholds and trigger times. Typically triggers to detect an event are low and high thresholds. Thereby different user-defined trigger conditions might be employed. For example fixed thresholds can be used as a trigger condition, e.g. if a heart rate drops below 100 beats per minute for a trigger time of 10 seconds. According to another preferred embodiment of the present invention relative thresholds are used by the analyzing module. A relative or deviation threshold is e.g. defined by the change of a measurement during a given time period. Such a relative threshold is exceeded for example if a heart rate drops by 20 percent within a time period of 10 minutes. Such relative thresholds can be used solely or in combination with other trigger types.

Preferably, the trigger conditions for each event are definable by a user, e.g. by clinical staff. In a preferred embodiment of the invention the trigger conditions are dynamically adapted e.g. depending on the acquired medical data.

According to a further embodiment of the invention the kind of event notification is user-definable, e.g. for each event group. Preferably a user-configurable awareness level can be assigned to the event notification. It includes besides a user prompt on a display, e.g. “Event Detection”, the possibility to alert on events with either a low, medium or high priority alarm. Thereby the alarming mechanisms already implemented in a patient monitor are preferably used.

Preferably for each event the user can define which type of detailed view is provided by the information providing module in order to be reviewed. The information provided by the information providing module as context information (“event episode”) includes for example a 20-minute average trend information or a 4-minute high resolution trend information or a 15-second real-time wave snapshot. The information providing module is adapted to capture the desired medical data and to store the medical data in a data storage device for further use. The medical context information provided allows the clinician to visualize e.g. the sequence of single events. For example the clinician can determine whether the heart rate dropped before the increase of the blood pressure. At the same time the clinician can view how the measurements recover after the event occurred.

These and other aspects of the invention will be described in detail hereinafter, by way of example, with reference to the following embodiments and the accompanying drawings; in which:

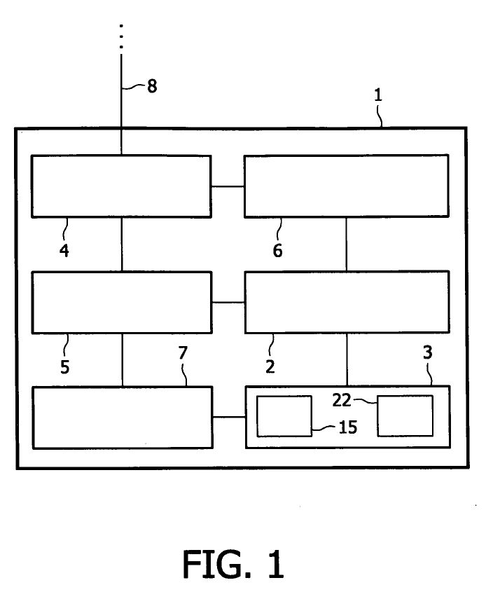

FIG. 1 is a block diagram showing an overview of a medical monitoring system,

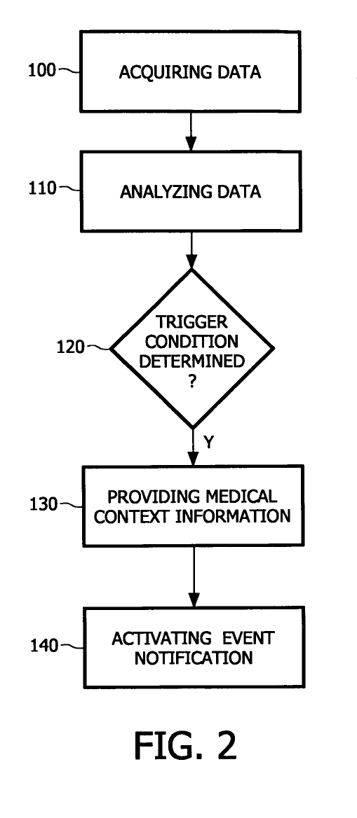

FIG. 2 is a flowchart illustrating a medical monitoring method,

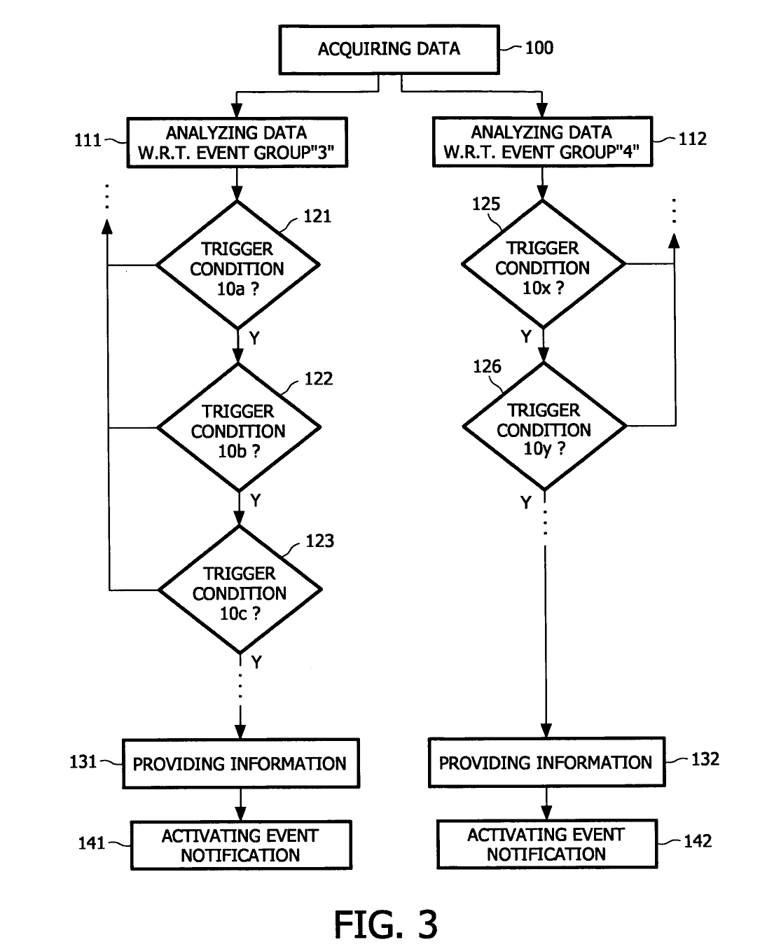

FIG. 3 is a flowchart illustrating a method with parallel event group analysing,

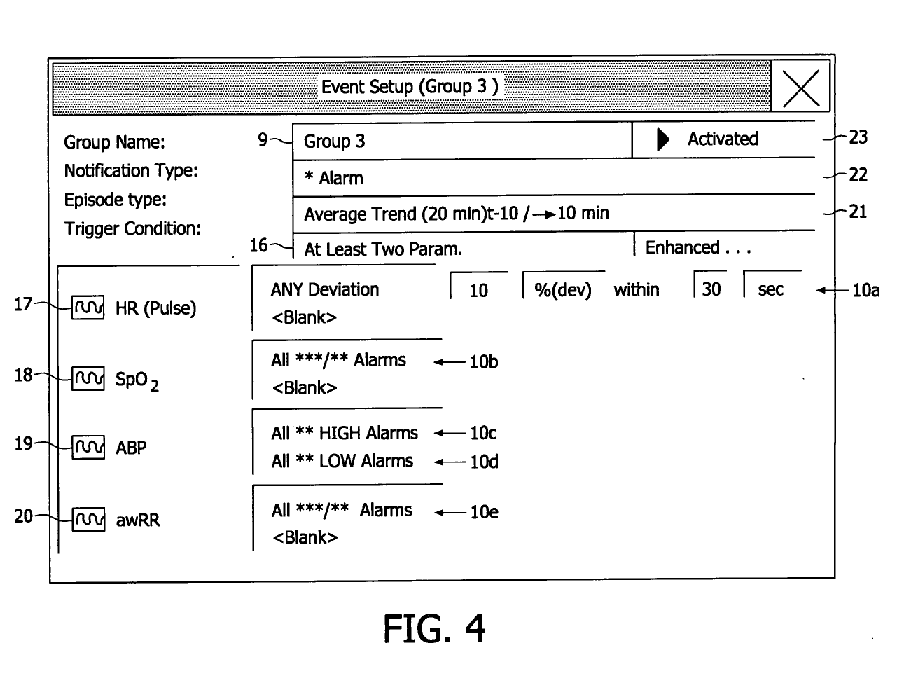

FIG. 4 is a monitor scheme illustrating the setup procedure of an event group,

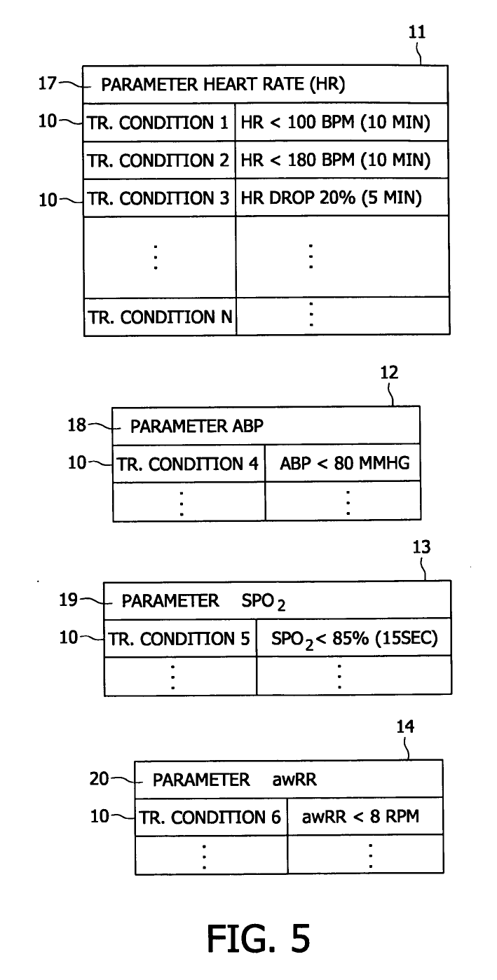

FIG. 5 is a schematic illustration of a user-defined trigger condition list, and

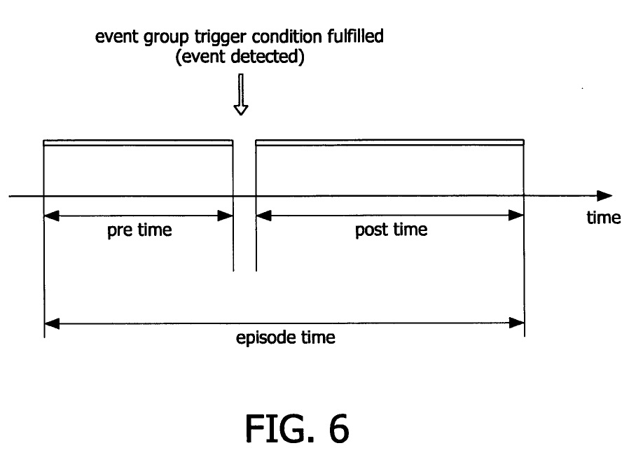

FIG. 6 is a schematic illustration of a user-defined event notification list.

FIG. 1 illustrates a medical monitoring system 1 for monitoring a patient (not shown) e.g. in a hospital room. The system 1 comprises a user input device 2, e.g. a touch screen or keyboard, and a display device 3, e.g. a monitor or printer. The system 1 is connectable to a software input device (not shown), e.g. a CD-ROM device, and/or to a computer network via a network interface. The system 1 further comprises a number of modules 4, 5, 6, 7 connected to each other and to the user input device 2 as well as to the display device 3. The modules 4, 5, 6, 7 are implemented as hardware and/or software. In other words the functions of these modules 4, 5, 6, 7 can be realized either on the basis of adequate hardware or on the basis of the instructions of a computer program or both. For this purpose the system 1 comprises computer means adapted to execute computer program instructions according to the invention.

The system 1 comprises an acquiring module 4 adapted to acquire medical data of a patient in a first step 100. For this purpose the acquiring module 4 is connected to a number of sensors (not shown) via data link 8.

Furthermore, the system 1 comprises an analyzing module 5. The analyzing module 5 is adapted to analyze in a next step 110 the medical data with respect to a number of event parameters 17, 18, 19, 20. As shown in FIG. 4, up to four event parameters are combined to form an event group 9. In the present embodiment up to six event groups can be activated in parallel. Each event group works independently of each other and can be activated or deactivated separately. The event parameters 17, 18, 19, 20 of the event group 9 illustrated in FIG. 4 are heart rate (HR), SpO₂ (oxygen saturation), ABP (arterial venous pressure) and awRR (airway respiration rate). The name of the event group can be chosen by the user during the event group setup. For example the name of the physician, the name of a department or the name of a disease pattern can be used. The event group shown in FIG. 4 has been named “group 3”. Each event group can be activated and deactivated by means of an activation switch 23 during setup. In the present case the activation switch 23 is implemented as an additional push button in the setup mask.

To each event parameter 17, 18, 19, 20 a number of user-definable trigger conditions 10 are assigned. In other words, the event detection is a hierarchic system consisting of event triggers, event parameters and event groups. In the present embodiment up to six event groups are used. Each event group consists of up to four event parameters and to each event parameter up to two triggers conditions 10 are assigned. Of course a larger number of trigger conditions can be assigned to an event parameter, if applicable. The trigger conditions 10 are freely definable by the user or can be selected by the user from a trigger condition list 11, 12, 13, 14, as shown in FIG. 5, where a number of predefined trigger conditions 10 are shown for each event parameter 9.

There are mainly four different kinds of triggers: alarm triggers, user-defined threshold triggers, user-defined deviation triggers and “On Measurement” triggers. The alarm trigger is configured to a parameter alarm. There are specific alarm triggers like “medium priority HIGH” and unspecific alarm triggers like “all high priority alarms”. Unspecific alarms include all alarms with the specified severity. User-defined threshold triggers are defined in terms of a threshold and a duration. The trigger condition is fulfilled if the threshold is exceeded for at least the specified duration. The threshold is specified in the parameter unit. A threshold trigger can be HIGH or LOW (respectively TACHY and BRADY for HR). The user-defined threshold trigger works as long as the parameter delivers its numerical value. The user-defined deviation trigger is configured in terms of deviation during a specified duration. The deviation can be relative (e.g. 10%) or absolute (e.g. 10 bpm). A relative deviation is specified in “% (dev)” to distinguish from unit % (e.g. SpO₂). All event parameters which allow user-defined threshold triggers support deviation triggers. There are three different kinds of deviation triggers: ANY deviation, where detection is independent of direction, UP Deviation, where only ascending deviations are detected, and DOWN Deviation, where only descending deviations are detected. To detect the deviation, values of different resolutions are used dependent on the configured duration. For example in the case of a duration of 10 seconds to 1 minute, samples of 1 second are used. Aperiodic parameters can be configured to trigger if a measurement occurs. The corresponding event string is “On Measurement”.

The first trigger condition list 11 comprises N trigger conditions 10 related to heart rate data of the patient. A second trigger condition list 12 comprises trigger conditions 10 related to ABP data of the patient. Other trigger condition lists 13, 14 are provided for SpO₂ and awRR etc.

Trigger condition “1” of the first trigger condition list 11 is determined if the patient's heart rate drops below 100 beats per minute for the last 10 minutes. Trigger condition “2” is determined, if the heart rate of the patient exceeds 180 beats per minute for the last 10 minutes. Instead of fixed thresholds, relative thresholds can be defined either by the user or automatically by means of the analysing module 5. For example trigger condition “3” is defined as a relative threshold. Trigger condition “3” is determined, if the heart rate of the patient drops 20 percent in 5 minutes. Trigger condition “4” of the second trigger condition list 12 is determined, if the ABP mean value drops below 80 mmHg. Trigger condition “5” of the third trigger condition list 13 is determined if the oxygen value drops below 85 percent for 15 seconds. Trigger condition “6” of the fourth parameter list 14 is determined if the awRR value drops below 8 rpm (respirations per minute).

In an advanced trigger condition list the trigger conditions are dynamically created depending on the acquired medical data. In another embodiment trigger conditions are automatically selected from the trigger condition list. For example the trigger condition “3” is selected automatically as an additional or new trigger condition for the event parameter HR by means of the analyzing module 5 in case the trigger condition “1” is determined.

In the present embodiment for the event parameter HR of event group “group 3” a first trigger condition 10a is already defined in the form of a relative threshold, which is determined, if there is a pulse change by 10 percent within 30 seconds, see FIG. 4. The second trigger condition of this event parameter is not defined and will remain free. For the event parameter SpO₂ a trigger condition 10b is set where any medium or high priority alarms that are defined for this parameter will lead to a single event condition. Two trigger conditions 10c, 10d are assigned to the event parameter ABP. Here the ABP condition is met, if the requirements for a medium priority HIGH alarm, i.e. an alarm because of exceeding a “HIGH” threshold, or the requirements of a medium priority LOW alarm, i.e. an alarm because of exceeding a “LOW” threshold, are fulfilled. In other words, the trigger conditions 10c, 10d are combined by a logical OR-operation. In case of the event parameter awRR the trigger condition 10e is any high or medium priority alarm.

The event parameters 17, 18, 19, 20 of each event group 9 are combined by an event group trigger condition 16. Five types of event group trigger conditions 16 are available: “at least one parameter”, “at least two parameters”, “at least three parameters”, “all four parameters”, and “enhanced”. The first four choices denote that at least the number of event parameters 17, 18, 19, 20 have to fulfill their trigger condition 10 to fulfill the event group trigger condition 16. The enhanced event group trigger condition allows the user to select each event parameter and each possible combination individually during the event group setup.

During the setup of the event group “group 3”, see FIG. 4, the user determines the event group trigger condition 16. Generally, an event is detected, if the specified event group trigger condition 16 is fulfilled. This leads to capturing and storing an event episode (medical context information 15) using the configured episode type. In the present embodiment the event group trigger condition “at least two parameters” is selected. In this case an event notification 22 is activated and medical context information 15 is provided, if the necessary trigger conditions 10 of at least two of the event parameters 17, 18, 19, 20 are determined.

If for example it is detected in step 120 that the heart rate has changed by 10 percent within 30 seconds (trigger 10a) and at the same time the requirements for a medium or high priority SpO₂ alarm are met (trigger 10b), an event notification 22 is activated and medical context information 15 is provided. For this purpose the system 1 comprises an information providing module 6 adapted to provide medical context information 15 in a subsequent step 130. The kind of event notification can be defined by the user in the event group setup. For the event group 9 illustrated in FIG. 4, a low priority alarm is activated. For other event groups other kinds of event notifications can be selected. The system 1 comprises a notification module 7 adapted to activate the event notification in step 140.

The type of medical context information 15 to be provided by the information providing module 6 can also be defined by the user during the event group setup. In the present example the medical context information 15 includes 20-minute average trend information. The information providing module 6 is adapted to capture the medical data, to store the medical data in an internal data storage device (not shown), to process this data and to provide the desired medical context information 15.

The available episode types 21 are average trend, high-resolution trend and real-time wave. The average trend covers 20 minutes and uses numeric average samples with 12s resolution taken from the trend database. High-resolution trend covers 4 min and uses 4 samples per second. Real-time wave covers 15 seconds, whereas the waves will be reduced to 125 samples per second and from 16 to 8 bits. During capturing the thresholds are frozen and the parameter is observed for its largest deviation. This so called maximum exceed is stored with the event episode. Capturing lasts the post time, see FIG. 6. During post time no new event is detected. A new event can be detected as soon as the last event's post time has expired and the formerly fulfilled trigger condition is not fulfilled anymore after the post time.

In a further embodiment of the invention it can be defined that the event notification is activated by the notification module only in cases where a number of events are detected simultaneously (“resulting event”).

If several event groups are provided, the determination of trigger conditions 10 is carried out subsequent to the data analysis in step 111 with regard to event group “3”. As illustrated in FIG. 3 the trigger conditions are verified in steps 121, 122, 123, . . . . In case the event group trigger condition 16 is fulfilled, the medical context information 15 is provided in step 131 and the event notification is activated (step 141). At the same time data analysis is carried out in step 112 with regard to another event group, e.g. event group “4”. The coresponding trigger conditions 10x, 10y, . . . are verified in steps 125, 126, . . . . In case the event group trigger condition 16 is fulfilled, the medical context information 15 is provided in step 132 and the event notification is activated (step 142). In case of a “resulting event” it can be defined, that the “resulting event” notification is activated not in addition but alternatively to the single event notifications in steps 141 and 142. If the event groups are defined in a way that each event group is assigned to a specific disease, a very early clinical diagnoses is possible.

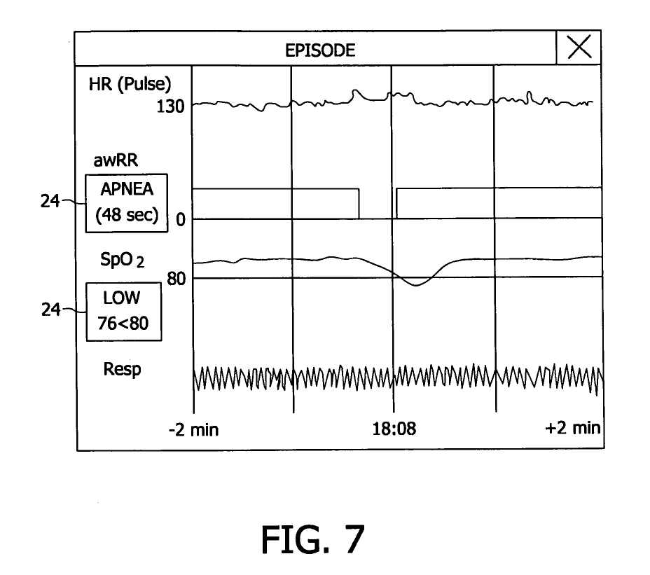

An example of the medical information 15 provided is given in FIG. 7. Therein an episode window is shown as presented to the user after an event has been detected. The event time is “18.08”. For two event parameters of the event group the event conditions are fulfilled. An apnea with a duration of 48 seconds has been detected according to the awRR-value. Additionally a LOW Alarm is given, because the SpO₂-value dropped below the threshold of 85 percent. Alert signs 24 for both single event conditions are shown together with the episode to inform the physician immediately about the present condition of the patient.

The present invention allows to define improved alarms by employing patient-independent deviation thresholds combined with an event notification based upon alarms.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects to be illustrative and not restrictive, the scope of the invention being indicated by the appended claims rather than by the foregoing description, and all changes which come within the meaning and range of equivalency of the claims are therefore intended to be embraced therein. It will furthermore be evident that the word “comprising” does not exclude other elements or steps, that the words “a” or “an” do not exclude a plurality, and that a single element, such as a computer system or another unit may fulfil the functions of several means recited in the claims. Any reference signs in the claims shall not be construed as limiting the claim concerned.

### REFERENCE LIST

1 medical monitor system
2 user input device
3 display device
4 acquiring device
5 analyzing device
6 information providing device
7 notification device
8 data link
9 event group
10 trigger condition
11 trigger condition list
12 trigger condition list
13 trigger condition list
14 trigger condition list
15 medical context information
16 event group trigger condition
17 event parameter
18 event parameter
19 event parameter
20 event parameter
21 episode type
22 event notification
23 activation switch
24 alert sign

1. A medical monitoring method, comprising the steps of
acquiring medical data of a patient,
analyzing the medical data with respect to a number of event parameters, whereas to each of the event parameters a number of user-definable trigger conditions are assigned,
and in case a number of said trigger conditions are detected
providing medical context information and
activating an event notifications.

2. The method as claimed in claim 1, wherein a number of event parameters are combined to form an event group.

3. The method as claimed in claim 2, wherein the analyzing of medical data is performed with respect to a number of different event groups at the same time.

4. The method as claimed in claim 1, wherein for an event parameter a number of trigger conditions are combined to form a trigger combination by means of mathematical and/or logical operators.

5. The method as claimed in claim 1, wherein a deviation threshold is used as a trigger condition.

6. The method as claimed in claim 1, comprising the further step of
adapting a trigger condition dynamically depending on the acquired medical data.

7. A medical monitoring system, comprising
an acquiring module adapted to acquire medical data of a patient,
an analyzing module adapted to analyze the medical data with respect to a number of event parameters, whereas to each of the event parameters a number of user-definable trigger conditions are assigned,
an information providing module adapted to provide medical context information, and
a notification module Readapted to activate an event notification in case a number of said trigger conditions are detected.

8. A computer program for controlling a medical monitoring system, the computer program comprising:
computer instructions to analyze medical data with respect to a number of event parameters, whereas a number of user-definable trigger conditions is assigned to each of the event parameters,
computer instructions to provide medical context information and computer instructions to activate an event notification in case a number of said trigger conditions are detected,
when the computer instructions are carried out in a computer.
